(19) United States
(12) Patent Application Publication
(10) Pub. No.: US 2018/0210270 A1
(43) Pub. Date: Jul. 26, 2018

(54) BACKLIGHT MODULE AND LIQUID CRYSTAL DISPLAY MODULE AND TELEVISION SET THEREOF

(71) Applicant: SHENZHEN CHINA STAR OPTOELECTRONICS TECHNOLOGY CO., LTD., Shenzhen, Guangdong (CN)

(72) Inventors: Dehua LI, Shenzhen, Guangdong (CN); Yuchun HSIAO, Shenzhen, Guangdong (CN); Gang YU, Shenzhen, Guangdong (CN)

(73) Assignee: Shenzhen China Star Optoelectronics Technology Co., Ltd., Shenzhen, Guangdong (CN)

(21) Appl. No.: 15/328,609

(22) PCT Filed: Jan. 7, 2017
(86) PCT No.: PCT/CN2017/070550

§ 371 Date: Jan. 24, 2017

(30) Foreign Application Priority Data
Dec. 6, 2016 (CN) 201611106095.0

(51) Int. Cl. G02F 1/1333; F21V 8/00

(52) U.S. Cl. CPC G02F 1/133308; G02B 6/0088; G02F 2001/133317; G02F 1/133385; G02B 6/0055

(57) ABSTRACT

The present disclosure proposes a backlight module having a middle frame, a back plate, an optical film arranged in the middle frame, a light guide plate arranged in the middle frame, and a reflective film arranged in the middle frame. A cavity is arranged in the middle frame. A liquid crystal panel is arranged on the middle frame. A plurality of first air-intake holes are evenly arranged and distributed on the surface of one side of the middle frame that is opposite to the liquid crystal panel. The first air-intake hole connected to the cavity. Compared with the related art, a liquid crystal display module fixed by means of vacuum adsorption is easy to be dismantled once the product with the liquid crystal display module is glitched or requires maintenance. The production cost is reduced since the liquid crystal display panel is not damaged when being dismantled.

### BACKGROUND

### 1. Field of the Disclosure

The present disclosure relates to the field of a liquid crystal display product, and more particularly, to a border-free backlight module and a border-free liquid crystal display module and a television set thereof.

### 2. Description of the Related Art

To attach and fax a conventional front border-free liquid crystal display product, a double-sided tape or glue is generally sandwiched between a liquid crystal panel and a middle frame. This method is simple and easy since the conventional structure of the product is not adjusted. However, it is hard to replace the old components with new ones when the product with the liquid crystal display module is glitched after assembly or requires maintenance. The adherence of the double-sided tape or glue is very forceful so it is very difficult in separating the liquid crystal panel from the middle frame, which may damage the liquid crystal panel easily as well. As a result, the reworking is low but the production cost increases.

### SUMMARY

To solve the problem of shortage occurring in the related art, the present disclosure aims to propose a backlight module and a liquid crystal display module and a television set adopting the backlight module and the liquid crystal display module to facilitate dismantlement or disassembly.

The present disclosure proposes a backlight module having a middle frame, a back plate, an optical film arranged in the middle frame, a light guide plate arranged in the middle frame, and a reflective film arranged in the middle frame. A cavity is arranged in the middle frame. A liquid crystal panel is arranged on the middle frame. A plurality of first air-intake holes are evenly arranged and distributed on the surface of one side of the middle frame that is opposite to the liquid crystal panel. The first air-intake hole connected to the cavity.

Furthermore, a miniature valve is arranged on the periphery of an outer area of the middle frame and connected to the cavity.

Furthermore, a first sealed silicone pad is arranged outside the first air-intake hole.

Furthermore, a second air-intake hole is well arranged and distributed on the surface of one side of the middle frame. The one side is opposite to the back plate. The second air-intake hole adsorbs the back plate to fix the middle frame and the back plate firmly after the air inside the cavity is completely removed.

Furthermore, a second sealed silicone pad seals an area between the middle frame and the back plate.

Furthermore, the first air-intake hole and the second air-intake hole are rounds.

Furthermore, the first air-intake hole and the second air-intake hole are rectangles.

The present disclosure proposes a liquid crystal display module including a liquid crystal panel, wherein the first air-intake absorbs the liquid crystal display to fix the liquid crystal display and the middle frame firmly after the air inside the cavity is completely removed; and a backlight module. The backlight module having a middle frame, a back plate, an optical film arranged in the middle frame, a light guide plate arranged in the middle frame, and a reflective film arranged in the middle frame. A cavity is arranged in the middle frame. A liquid crystal panel is arranged on the middle frame. A plurality of first air-intake holes are evenly arranged and distributed on the surface of one side of the middle frame that is opposite to the liquid crystal panel. The first air-intake hole connected to the cavity.

Furthermore, a miniature valve is arranged on the periphery of an outer area of the middle frame and connected to the cavity.

Furthermore, a first sealed silicone pad is arranged outside the first air-intake hole.

Furthermore, a second air-intake hole is well arranged and distributed on the surface of one side of the middle frame. The one side is opposite to the back plate. The second air-intake hole adsorbs the back plate to fix the middle frame and the back plate firmly after the air inside the cavity is completely removed.

Furthermore, a second sealed silicone pad seals an area between the middle frame and the back plate.

Furthermore, the first air-intake hole and the second air-intake hole are rounds.

Furthermore, the first air-intake hole and the second air-intake hole are rectangles.

The present disclosure proposes a television set including a liquid crystal display module which includes a liquid crystal panel, wherein the first air-intake absorbs the liquid crystal display to fix the liquid crystal display and the middle frame firmly after the air inside the cavity is completely removed; and a backlight module. The backlight module having a middle frame, a back plate, an optical film arranged in the middle frame, a light guide plate arranged in the middle frame, and a reflective film arranged in the middle frame. A cavity is arranged in the middle frame. A liquid crystal panel is arranged on the middle frame. A plurality of first air-intake holes are evenly arranged and distributed on the surface of one side of the middle frame that is opposite to the liquid crystal panel. The first air-intake hole connected to the cavity.

Furthermore, a miniature valve is arranged on the periphery of an outer area of the middle frame and connected to the cavity.

Furthermore, a first sealed silicone pad is arranged outside the first air-intake hole.

Furthermore, a second air-intake hole is well arranged and distributed on the surface of one side of the middle frame. The one side is opposite to the back plate. The second air-intake hole adsorbs the back plate to fix the middle frame and the back plate firmly after the air inside the cavity is completely removed.

Furthermore, a second sealed silicone pad seals an area between the middle frame and the back plate.

Furthermore, the first air-intake hole and the second air-intake hole are rounds.

Furthermore, the first air-intake hole and the second air-intake hole are rectangles.

Compared with the related art where a double-sided tape or glue is used, the method of vacuum adsorption adopted in the present disclosure has advantages. A liquid crystal display module fixed by means of vacuum adsorption is easy to be dismantled once the product with the liquid crystal display module is glitched or requires maintenance. Also, the production cost is reduced since the liquid crystal display panel is not damaged when being dismantled.

### BRIEF DESCRIPTION OF THE DRAWINGS

FIG. 1 illustrates a schematic diagram of a backlight module according to a first embodiment of the present disclosure.

FIG. 2 illustrates a schematic diagram of an assembled backlight module of FIG. 1.

FIG. 3 illustrates a schematic diagram of a backlight module according to a second embodiment of the present disclosure.

FIG. 4 illustrates a schematic diagram of an assembled backlight module of FIG. 3.

FIG. 5 illustrates first air-intake holes and second air-intake holes on a middle frame according to an embodiment of the present disclosure.

FIG. 6 illustrates first air-intake holes and second air-intake holes on a middle frame according to another embodiment of the present disclosure.

### DETAILED DESCRIPTION OF THE PREFERRED EMBODIMENTS

The drawings illustrate embodiments of the invention and, together with the description, serve to explain the principles of the invention.

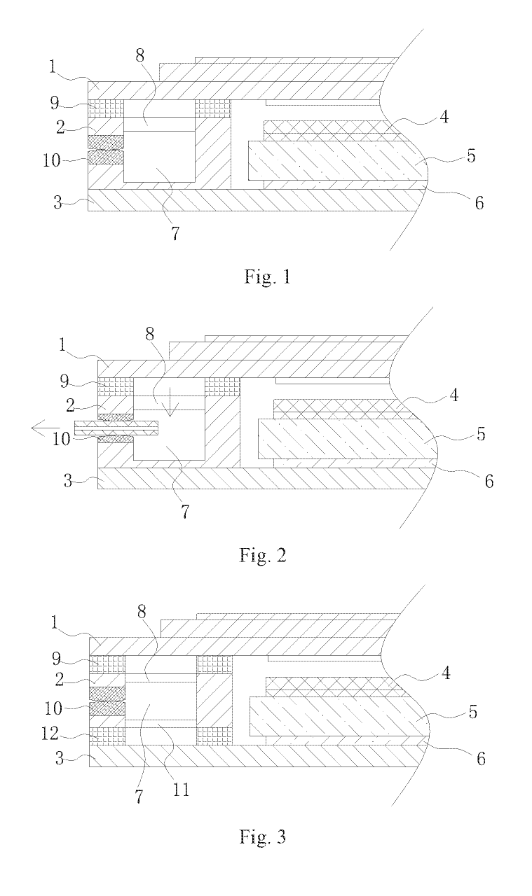

As FIG. 1 shows, a backlight module proposed by a first embodiment includes a middle frame 2, a back plate 3, an optical film 4 arranged in the middle frame 2, a light guide plate 5 arranged in the middle frame 2, and a reflective film 6 arranged in the middle frame 2. A liquid crystal panel 1 is arranged on the middle frame 2. A cavity 7 is arranged inside the middle frame 2. A plurality of first air-intake holes 8 are evenly arranged and distributed on the surface of one side of the middle frame 2. The one side is opposite to the liquid crystal panel 1. The first air-intake hole 8 is connected to the cavity 7. A first sealed silicone pad 9 is arranged outside the first air-intake hole 8. A miniature valve 10 is arranged on the periphery of an outer area of the middle frame 2 and connected to the cavity 7. The miniature valve 10 is connected to the middle frame 2 airtightly.

The assembly method of the liquid crystal panel 1 proposed by the first embodiment is shown in FIG. 2. Firstly, the back plate 3 is attached to the middle frame 2. Next, the reflective film 6, the light guide plate 5, and the optical film 4 ate arranged on the back plate 3 in the middle frame 2 sequentially. Next, a backlight source is arranged on both sides of the reflective film 6, the light guide plate 5, and the optical film 4. The liquid crystal panel 1 is arranged on the surface of one side where the first air-intake hole 8 is arranged on. The first sealed silicone pad 9 is arranged outside the first air-intake hole 8 and used to seal the area between the liquid crystal panel 1 and the middle frame 2. A needle is inserted in the miniature valve 10 and used to remove the air in the cavity 7. The liquid crystal panel 1 is attached and fixed by means of atmospheric pressure. In this way, it is not necessary to use the double-sided tape or glue. Once a liquid crystal display module is glitched or keeps maintenance and needs to be dismantled, the simplest solution is to insert a needle in the miniature valve 10 to let the air enter the miniature valve 10 via the needle. After the air enters the miniature valve 10, the liquid crystal panel 1 and the backlight component are departed. Not only the difficulty in dismantling the liquid crystal panel 1 and the backlight component is lowered, but also the liquid crystal panel 1 is less invulnerable, which lowers the production cost at last.

As FIG. 3 shows, the difference between the backlight module in the second embodiment and the backlight module in the first embodiment is that a back plate 3 and a middle frame 2 are fixed via absorption as well. Specifically, a cavity 7 is arranged in a middle frame 2. A first air-intake hole 8 is well arranged and distributed on the surface of one side of the middle frame 2. The one side is opposite to the liquid crystal panel 1. A first sealed silicone pad 9 is arranged outside the first air-intake hole 8. A miniature valve 10 is arranged on the periphery of an outer area of the middle frame 2 and connected to the cavity 7. The miniature valve 10 is connected to the middle frame 2 airtightly. A plurality of second air-intake holes 11 are evenly arranged and distributed on the surface of one side of the middle frame 2. The one side is opposite to the back plate 3. After the air inside the cavity 7 is completely removed, the second air-intake hole 11 adsorbs the, back plate 3 so that the middle frame 2 and the back plate 3 can be firmly fixed. A second sealed silicone pad 12 is arranged outside the second air-intake hole 11 and used to seal the area between the middle frame 2 and the back plate 3.

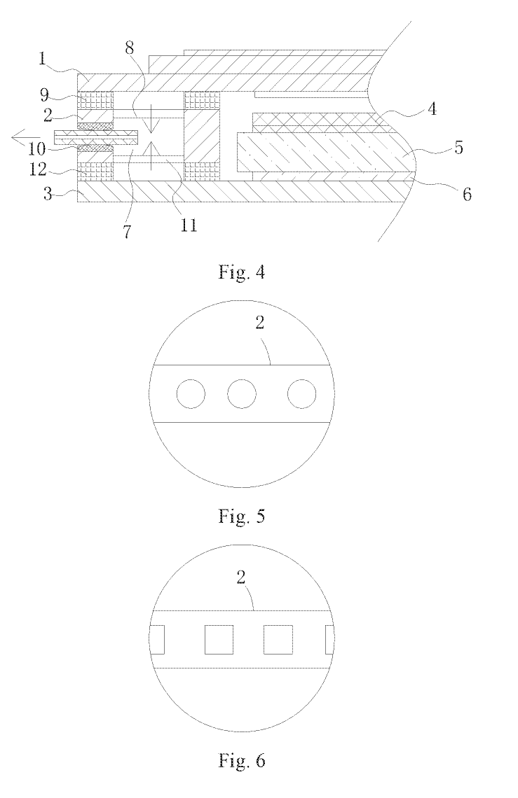

The assembly method of the liquid crystal panel 1 proposed by the second embodiment is shown in FIG. 4. Firstly, the back plate 3 is attached to the surface of one side of the middle frame 2 where the second air-intake hole 11 is arranged. Next, the reflective film 6, the light guide plate 5, and the optical film 4 ate arranged on the back plate 3 in the middle frame 2 sequentially. Next, a backlight source is arranged on both sides of the reflective film 6, the light guide plate 5, and the optical film 4. The liquid crystal panel 1 is arranged on the surface of one side where the first air-intake hole 8 is arranged on. The first sealed silicone pad 9 is arranged outside the first air-intake hole 8 and used to seal the area between the liquid crystal panel 1 and the middle frame 2. The second sealed silicone pad 12 is arranged outside the second air-intake hole 11 and used to seal the area between the back plate 3 and the middle frame 2. A needle is inserted in the miniature valve 10 and used to remove the air in the cavity 7. The liquid crystal panel 1 and the back plate 3 are attached and fixed by means of atmospheric pressure. Up to now, the assembly is complete.

As shown in FIG. 5 and FIG. 6, the first air-intake hole 8 and the second air-intake hole 11 can he shaped like a round or a rectangle. The first air-intake hole 8 and the second air-intake hole 11 both are arranged at intervals.

According to the present disclosure, the liquid crystal display module includes a liquid crystal panel 1 and a backlight module as provided in the first embodiment or the second embodiment. The first air-intake hole 8 sticks to the liquid crystal panel 1 to fix the liquid crystal panel 1 and the middle frame 2 firmly after the air inside the cavity 7 is completely removed. The first sealed silicon pad 9 is used to seal gap between the liquid crystal panel 1 and the middle frame 2.

According to the present disclosure, a television set includes a liquid crystal module that includes a liquid crystal panel 1 and a backlight module as provided in the first embodiment or the second embodiment. The first air-intake hole 8 sticks to the liquid crystal panel 1 to fix the liquid crystal panel 1 and the middle frame 2 firmly after the air inside the cavity 7 is completely removed. The first sealed silicon pad 9 is used to seal gap between the liquid crystal panel 1 and the middle frame 2.

Above are embodiments of the present invention, which does not limit the scope of the present invention. Any modifications, equivalent replacements or improvements within the spirit and principles of the embodiment described above should be covered by the protected scope of the invention.

What is claimed is:

1. A backlight module, comprising: a middle frame, a back plate, an optical film arranged in the middle frame, a light guide plate arranged in the middle frame, and a reflective film arranged in the middle frame; a cavity arranged in the middle frame; a liquid crystal panel arranged on the middle frame; a plurality of first air-intake holes evenly arranged and distributed on the surface of one side of the middle frame that is opposite to the liquid crystal panel; the first air-intake hole connected to the cavity.

2. The backlight module of claim 1, wherein a miniature valve is arranged on the periphery of an outer area of the middle frame and connected to the cavity.

3. The backlight module of claim 1, wherein a first sealed silicone pad is arranged outside the first air-intake hole.

4. The backlight module of claim 2, wherein a first sealed silicone pad is arranged outside the first air-intake hole.

5. The backlight module of claim 1, wherein a second air-intake hole is well arranged and distributed on the surface of one side of the middle frame; the one side is opposite to the back plate; the second air-intake hole adsorbs the back plate to fix the middle frame and the back plate firmly after the air inside the cavity is completely removed.

6. The backlight module of claim 5, wherein a second sealed silicone pad seals an area between the middle frame and the back plate.

7. A liquid crystal display module, comprising a liquid crystal panel and a backlight module; the backlight module comprising a middle frame, a back plate, an optical film arranged in a middle frame, a light guide plate arranged in the middle frame, and a reflective film arranged in the middle frame; a cavity arranged in the middle frame; a liquid crystal panel arranged on the middle frame; a plurality of first air-intake holes evenly arranged and distributed on the surface of one side of the middle frame that is opposite to the liquid crystal panel; the first air-intake hole connected to the cavity; the first air-intake hole adsorbing the liquid crystal panel to fax the liquid crystal panel and the middle frame firmly after the air inside the cavity is completely removed.

8. The liquid crystal display module of claim 7, wherein a miniature valve is arranged on the periphery of an outer area of the middle frame and connected to the cavity.

9. The liquid crystal display module of claim 7, wherein a first sealed silicone pad is arranged outside the first air-intake hole.

10. The liquid crystal display module of claim 8, wherein a first sealed silicone pad is arranged outside the first air-intake hole.

11. The liquid crystal display module of claim 7, wherein a second air-intake hole is well arranged and distributed on the surface of one side of the middle frame; the one side is opposite to the back plate; the second air-intake hole adsorbs the back plate to fix the middle frame and the back plate firmly after the air inside the cavity is completely removed.

12. The liquid crystal display module of claim 11, wherein a second sealed silicone pad seals an area between the middle frame and the back plate.

13. A television set comprising a liquid crystal display module which comprises a liquid crystal panel and a backlight module; the backlight module comprising a middle frame, a back plate, an optical film arranged in a middle frame, a light guide plate arranged in the middle frame, and a reflective film arranged in the middle frame; a cavity arranged in the middle frame; a liquid crystal panel arranged on the middle frame; a plurality of first air-intake holes evenly arranged and distributed on the surface of one side of the middle frame that is opposite to the liquid crystal panel; the first air-intake hole connected to the cavity; the first air-intake hole adsorbing the liquid crystal panel to fix the liquid crystal panel and the middle frame firmly after the air inside the cavity is completely removed.

14. The television set of claim 13, wherein a miniature valve is arranged on the periphery of an outer area of the middle frame and connected to the cavity.

15. The television set of claim 13, wherein a first sealed silicone pad is arranged outside the first air-intake hole.

16. The television set of claim 15, wherein a first sealed silicone pad is arranged outside the first air-intake hole.

17. The television set of claim 13, wherein a second air-intake hole is well arranged and distributed on the surface of one side of the middle frame; the one side is opposite to the back plate; the second air-intake hole adsorbs the back plate to fix the middle frame and the back plate firmly after the air inside the cavity is completely removed.

18. The television set of claim 17, wherein a second sealed silicone pad seals an area between the middle frame and the back plate.
